(19) United States
(12) Patent Application Publication
(10) Pub. No.: US 2010/0224828 A1
(43) Pub. Date: Sep. 9, 2010

(54) PHOSPHOR, PHOSPHOR PASTE CONTAINING THE SAME, AND LIGHT-EMITTING DEVICE

(75) Inventors: Satoru Kuze, Tsukuba (JP); Yoshiko Nakamura, Higashimurayama (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company Limited, Chuo-ku Tokyo (JP)

(21) Appl. No.: 12/376,449

(22) PCT Filed: Aug. 3, 2007
(86) PCT No.: PCT/JP2007/065685

§ 371 Date: Mar. 19, 2009

(30) Foreign Application Priority Data
Aug. 10, 2006 (JP) 2006 217969
Oct. 25, 2006 (JP) 2006 289741

(51) Int. Cl. C09K 11/79; C09K 11/66; C09K 11/67

(52) U.S. Cl. 252/301.4 F

(57) ABSTRACT

Disclosed is a phosphor having high luminance. This phosphor includes an oxide containing M¹, M² and M³ (wherein M¹ represents at least two elements selected from the group consisting of Ba, Sr and Ca; M² represents at least one element selected from the group consisting of Ti, Zr and Hf; and M³ represents at least one element selected from the group consisting of Si and Ge) as a base material, while being added with an activator.

### TECHNICAL FIELD

The present invention relates to a phosphor, a phosphor paste containing it, and a light-emitting device.

### BACKGROUND ART

The phosphors emit light when exposed to an excitation source, so that they are used for the light-emitting devices. There are known the various types of light-emitting devices, which include, for instance, electron beam-excited light-emitting devices which make use of electron beams as the phosphor excitation source (such as CRT, field emission display and surface field display), ultraviolet light-excited light-emitting devices using ultraviolet light as the phosphor excitation source (such as backlight for liquid crystal display, three-wavelength type fluorescent lamp and high-load fluorescent lamp), vacuum ultraviolet light-excited light-emitting devices using vacuum ultraviolet light as the phosphor excitation source (such as plasma display panel and rare gas lamp), and white LED using light emitted by blue LED or ultraviolet LED as the phosphor excitation source.

As conventional phosphors, there is known a phosphor for vacuum ultraviolet light-excited light-emitting devices, which is represented by the formula Ba_{0.98}ZrSi₃O₉:Eu_{0.02} (JP-A-2006-2043).

The conventional phosphor, however, is unsatisfactory in luminance.

### DISCLOSURE OF THE INVENTION

The present invention is envisioned to provide a phosphor showing high luminance when it emits light, a phosphor paste using such a phosphor, and a light-emitting device.

The present inventors have pursued studies for solving the above problem and, as a result, reached the present invention.

The present invention provides <1> to <8> set forth below:

<1> A phosphor comprising:

an oxide containing M¹, M² and M³ (wherein M¹ represents at least two elements selected from the group consisting of Ba, Sr and Ca; M² represents at least one element selected from the group consisting of Ti, Zr and Hf; and M³ represents at least one element selected from the group consisting of Si and Ge) as a base material; and

(an) activator(s).

<2> The phosphor according to item <1> wherein the oxide containing M¹, M² and M³ is represented by the formula (1):

aM¹O.bM²O₂.cM³O₂ (1)

wherein M¹ represents at least two elements selected from the group consisting of Ba, Sr and Ca;

M² represents at least one element selected from the group consisting of Ti, Zr and Hf;

M³ represents at least one element selected from the group consisting of Si and Ge;

a is not less than 0.5 and not more than 1.5;

b is not less than 0.5 and not more than 1.5; and

c is not less than 2 and not more than 4.

<3> The phosphor according to item <1> or <2> wherein the activator is Eu.
<4> The phosphor according to any one of items <1> to <3> wherein M¹ is Ba and Sr.
<5> A phosphor represented by the formula (2):

(Ba_{1-x-y}SrₓEu_{y})ZrSi₃O₉ (2)

wherein x is not less than 0.2 and not more than 0.8;

y is not less than 0.0001 and not more than 0.5; and

x+y=0.8 or less.

<6> A phosphor paste containing the phosphor according to any one of items <1> to <5>.
<7> A phosphor layer obtained by applying the phosphor paste according to item <6> on a substrate, followed by a heat treatment.
<8> A light-emitting device having incorporated therein the phosphor according to any one of items <1> to <5>.

### BRIEF DESCRIPTION OF THE DRAWINGS

FIG. 1 is an X-ray diffraction pattern of the phosphor 1.

FIG. 2 is an x-ray diffraction pattern of the phosphor 3.

FIG. 3 is an x-ray diffraction pattern of the phosphor 5.

FIG. 4 is an X-ray diffraction pattern of the phosphor 6.

### MODE FOR CARRYING OUT THE INVENTION

### Phosphor

The phosphor according to the present invention comprises: an oxide containing M¹, M² and M³ (wherein M¹ represents at least two elements selected from the group consisting of Ba, Sr and Ca; M² represents at least one element selected from the group consisting of Ti, Zr and Hf; and M³ is Si and/or Ge) as a base material; and also contains an activator. This phosphor emits light with high luminance when exposed to an excitation source, so that it finds very useful application to the light-emitting devices.

The oxide composing the base of the phosphor emits light when exposed to an excitation source as it contains an activator. More specifically, part of the elements composing the base material of the phosphor is substituted with an element which functions as an activator to constitute a phosphor which emits light upon being exposed to an excitation source. The elements that can serve as an activator include Eu, Ce, Pr, Nd, Sm, Tb, Dy, Er, Tm, Yb, Bi and Mn.

The oxides containing M¹, M² and M³ (wherein M¹, M² and M³ have the same meanings as defined above) used in the present invention are preferably those represented by the following formula (1) for the enhancement of luminance:

aM¹O.bM²O₂.cM³O₂ (1)

wherein a is a numerical value falling in the range of from 0.5 to 1.5; b is a numerical value falling in the range of from 0.5 to 1.5; and c is a numerical value falling in the range of from 2 to 4.

For maximizing the phosphor luminance, the activator contained in the phosphor is preferably Eu, particularly Eu with a high ratio of divalent Eu ions. When the activator is Eu, luminance may be further enhanced by substituting part of Eu with a co-activator. The co-activator may comprise one or more elements selected from the group consisting of Al, Sc, Y, La, Gd, Ce, Pr, Nd, Pm, Sm, Tb, Dy, Ho, Er, Tm, Yb, Lu, Bi, Au, Ag, Cu and Mn. The rate of substitution of Eu is normally 50 mol % or less.

For increasing luminance, M¹ preferably contains Ba and Sr, and more preferably it consists of Ba and Sr.

The phosphor of the present invention is preferably one which is represented by the following formula (2):

(Ba_{1-x-y}SrₓEu_{y})ZrSi₃O₉ (2)

wherein x is a numerical value falling in the range of from 0.2 to 0.8; y is a numerical value falling in the range of from 0.0001 to 0.5; and x+y=0.8 or less. This phosphor emanates light with high luminance when exposed to an excitation source, so that it is useful for application to the light-emitting devices.

In the above formula (2), x is preferably a value falling in the range of from 0.2 to 0.6 for providing higher luminance, while y is preferably a value falling in the range of from 0.001 to 0.1 in view of the balance between luminance achievable and production cost. Also in the formula (2), Eu denotes an activator.

The crystal structure of the phosphor is usually of the benitoite type. This crystal structure can be identified by X-ray diffractometry.

The phosphor according to the present invention can be produced, for instance, in the following way. A mixture of the metallic compounds comprising a composition capable of becoming the phosphor of the present invention is baked. Specifically, the compounds containing the particular metallic elements are weighed out and mixed so as to provide a prescribed composition and the resultant mixture of the metallic compounds is baked. For instance, the phosphor represented by the formula Ba_{0.6}Sr_{0.38}ZrSi₃O₉:Eu_{0.02}, which is one of the preferable compositions, can be produced by weighing out and mixing the starting compounds BaCO₃, SrCO₃, ZrO₂, SiO₂ and Eu₂O₃ in the molar ratio of Ba:Sr:Zr:Si:Eu=0.6:0.38:1:3:0.02, and baking this mixture of the metallic compounds.

The compounds containing the particular metallic elements are the compounds of Ba, Sr, Ca, Ti, Zr, Hf, Si, Ge, Eu, Al, Sc, Y, La, Gd, Ce, Pr, Nd, Pm, Sm, Tb, Dy, Ho, Er, Tm, Yb, Lu, Bi, Au, Ag, Cu and Mn. These compounds can be used in the form of an oxide or in the form that can be turned into an oxide by high temperature decomposition and/or oxidation, such as hydroxides, carbonates, nitrates, halides and oxalates.

Mixing of the compounds containing the specific metallic elements can be accomplished by a conventional industrial mixing machine such as ball mill, V-type mixer and stirrer. Mixing may be either dry type or wet type. It is also possible to obtain a metallic compound mixture of a desired composition by a crystallization method.

The metallic compound mixture is baked, for instance, at a temperature in the range of from 600° C. to 1,600° C. for a period of from 0.5 to 100 hours inclusive to obtain a phosphor of the present invention. In case the phosphor to be obtained is one represented by the above-shown formula (2), the preferred range of baking temperature is from 1,300° C. to 1,500° C. inclusive. In case of using the compounds that can be decomposed at high temperature and/or oxidized such as hydroxide, carbonate, nitrate, halide and oxalate for the mixture, calcination may be carried out at a temperature in the range of from 400° C. to 1,600° C. to make an oxide and then, or after removing the crystal water, the above-described baking may be conducted. The atmosphere in which calcination is carried out may be an inert gas atmosphere, an oxidative atmosphere or a reducing atmosphere. The calcined product may be pulverized.

The baking atmosphere is preferably an atmosphere of an inert gas such as nitrogen or argon; an oxidizing atmosphere such as air, oxygen, oxygen-containing nitrogen or oxygen-containing argon; or a reducing atmosphere such as an atmosphere of hydrogen-containing nitrogen with a hydrogen content of 0.1 to 10% by volume or hydrogen-containing argon with a hydrogen content of 0.1 to 10% by volume. In case baking is carried out in a strongly reducing atmosphere, a pertinent amount of carbon may be contained in the metallic compound mixture.

By using a fluoride, a chloride or the like as the compound containing the specific metallic elements, it is possible to enhance crystallizability and/or to increase average particle size of the produced phosphor. Also, to this end, a proper amount of a flux may be added to the metallic compound mixture. As the flux, there can be used, for instance, LiF, NaF, KF, LiCl, NaCl, KCl, Li₂CO₃, Na₂CO₃, K₂CO₃, NaHCO₃, NH₄Cl, NH₄I, MgF₂, CaF₂, SrF₂, BaF₂, MgCl₂, CaCl₂, SrCl₂, BaCl₂, MgI₂, CaI₂, SrI₂ and BaI₂.

The obtained phosphor may be pulverized by a suitable means such as ball mill or jet mill, cleaned and classified as required. Baking may be conducted two or more times. Also, the produced phosphor particles may be subjected to a surface treatment such as coating with an inorganic material containing Si, Al, Ti or the like.

### Phosphor Paste

The phosphor paste according to the present invention comprises as its main components the above-described phosphor of the present invention and (an) organic material(s) which may be, for instance, a solvent or a binder. This phosphor paste can be used in the same way as the conventional phosphor paste used in the manufacture of the light-emitting devices. The organic material in the paste can be removed by evaporation, combustion, decomposition or other means by subjecting the paste to a heat treatment, making it possible to obtain a phosphor layer which is substantially composed of a phosphor of the present invention.

The phosphor paste can be produced by a known method such as disclosed in JP-A-10-255671. For instance, it can be obtained by mixing a phosphor, a binder and a solvent by a ball mill, three-roll mill or like means.

The binders usable in the present invention include cellulosic resins (such as ethyl cellulose, methyl cellulose, nitrocellulose, acetyl cellulose, cellulose propionate, hydroxypropyl cellulose, butyl cellulose, benzyl cellulose and modified cellulose), acrylic resins (polymers comprising at least one of the monomers such as acrylic acid, methacrylic acid, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, benzyl acrylate, benzyl methacrylate, phenoxy acrylate, phenoxy methacrylate, isobonyl acrylate, isobonyl methacrylate, glycidyl methacrylate, styrene, α-methylstyrene acrylamide, methacrylamide, acrylonitrile, and methacrylonitrile), ethylene-vinyl acetate copolymer resins, polyvinyl butyral, polyvinyl alcohol, propylene glycol, polyethylene oxide, urethane resins, melamine resins, and phenolic resins.

As the solvent, it is possible to use, for instance, monohydric alcohols of high boiling point; polyhydric alcohols such as diols and triols the representative examples of which are ethylene glycol and glycerin; and the compounds formed by etherifying and/or esterifying alcohols (such as ethylene glycol monoalkyl ether, ethylene glycol dialkyl ether, ethylene glycol alkyl ether acetate, diethylene glycol monoalkyl ether acetate, diethylene glycol dialkyl ether, propylene glycol monoalkyl ether, propylene glycol dialkyl ether, and propylene glycol alkyl acetate).

The phosphor layer formed by coating the thus obtained phosphor on a substrate and subjecting it to a heat treatment has excellent moisture resistance. The substrate may be, for instance, one made of glass or resin. Also, it may be of a flexible type, and its shape is diversified, such as plate-like or vessel-like. Screen printing, ink jet printing or other like methods may be used for coating. The temperature for the heat treatment usually ranges from 300° C. to 600° C. Drying at from room temperature to 300° C. may be conducted prior to the heat treatment after coating on the substrate.

### Light-Emitting Devices

A plasma display panel, which is a vacuum UV-excited light-emitting device, is taken up here as an example of the light-emitting devices according to the present invention, and its production process is illustrated below. The conventional methods such as disclosed in JP-A-10-195428 can be used for producing a plasma display panel. In case the above-described phosphor is one which emits light of blue color, each phosphor, viz. a green phosphor, a red phosphor or the above-mentioned blue phosphor, is mixed with a binder composed of, for instance, a cellulose resin and polyvinyl alcohol and a solvent to prepare a phosphor paste. This phosphor paste is coated by a suitable means such as screen printing on the partition wall surface and the striped substrate surface provided with an address electrode and comparted by a partition wall on the inside of the back substrate, and heat treated at a temperature in the range of from 300 to 600° C. to obtain a phosphor layer. A frontal glass substrate provided with a transparent electrode and a bus electrode positioned in the direction perpendicular to the phosphor layer and also having on its inner side a dielectric layer and a protective layer is placed and bonded on these phosphor layers. The inside of the assembly is evacuated and filled with a low pressure rare gas such as Xe or Ne to form a discharge space, thus producing a plasma display panel.

A field emission display, which is an electron beam-excited light-emitting device, taken up here as another example of the light-emitting devices according to the present invention is described below regarding its production process. A known method such as disclosed in JP-A-2002-138279 can be used for producing a field emission display. In case the above-described phosphor is one which emits light of blue color, each phosphor, viz. a green phosphor, a red phosphor or the above-mentioned blue phosphor, is dispersed in an aqueous solution of polyvinyl alcohol or the like to prepare a phosphor paste. This phosphor paste is applied on a glass substrate and heat treated to form a phosphor layer, thus making a face plate. This face plate and a rear plate having a plurality of electron releasing elements are assembled together with the aid of a support frame and the assembly is passed through the ordinary steps such as hermetic sealing while evacuating the spaces in the assembly, thereby making a field emission display.

The production process of a white LED, yet another example of the light-emitting devices according to the present invention, is explained below. The known methods such as disclosed in JP-A-5-152609 and JP-A-7-99345 can be used for producing a white LED. The phosphors including at least the above-described phosphor are dispersed in a light-transmitting resin such as epoxy resin, polycarbonate or silicon rubber, and the phosphors-dispersed resin is molded in such a manner as to enclose the blue LED or ultraviolet LED, thereby producing a white LED.

The production process of a high-load fluorescent lamp (a small-sized fluorescent lamp with a high power consumption per unit area of the lamp pipe wall), which is a UV-excited light-emitting device and cited here as still another example of the light-emitting devices according to the present invention, is described below. A known method such as described in JP-A-10-251636 can be used for producing a high-load fluorescent lamp. In case the above-described phosphor is one which emits light of blue light, each of the compositional phosphors, viz. a green phosphor, a red phosphor and the above-described particulate blue phosphor is dispersed in an aqueous solution of polyethylene oxide or the like to prepare a phosphor paste. This phosphor paste is applied on the inner wall of the glass tube, dried and then heat treated at a temperature in the range of from 300 to 600° C. to form a phosphor layer. After attaching filaments, the phosphor layer is passed through the ordinary steps such as evacuation, then a low pressure rare gas such as Ar, Kr or Ne is sealed therein and caps are mounted so as to form a discharge space, thereby making a high-load fluorescent lamp.

### EXAMPLES

The present invention is further illustrated by its embodiments. The crystal structure of the phosphors was analyzed by powder X-ray diffractometry using characteristic X-rays of CuKα with an X-ray diffractometer RINT2500TTR mfd. by Rigaku Co., Ltd.

### Comparative Example 1

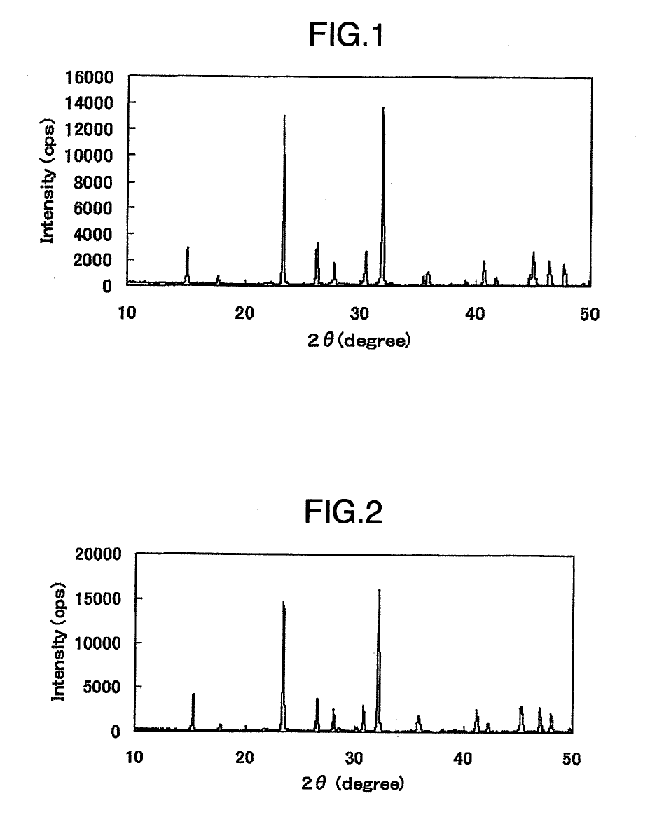

Barium carbonate (produced by Nippon Chemical Industries Co., Ltd.; purity: 99% or above), zirconium oxide (produced by Wako Pure Chemical Industries Co., Ltd.; purity: 99.99%), silicon dioxide (produced by Nippon Aerogil Co., Ltd.; purity: 99.99%) and europium oxide (produced by Shin-Etsu Chemical Industries Co., Ltd.; purity: 99.99%) were weighed out to have a composition of Ba:Zr:Si:Eu=0.98:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,450° C. for 5 hours to obtain a phosphor 1 represented by the formula Ba_{0.98}ZrSi₃O₉:Eu_{0.02}. The X-ray diffraction pattern of the phosphor 1 is shown in FIG. 1. It was found from FIG. 1 that the phosphor 1 had a benitoite type crystal structure.

The phosphor 1 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp.). The emitted light was of blue color with the peak of light emission at 480 nm. The luminance of the emitted light observed at that moment is here assumed to be 100. (Hereinafter, luminance of the phosphors resulting from excitation by 146 nm light exposure is shown as a relative value to the luminance of the phosphor 1 which is assumed to be 100.) The results of measurement of luminance of the phosphors on excitation by 146 nm light exposure are shown in Table 1.

The phosphor 1 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp.). The emitted light was of blue color with the peak of light emission at 480 nm. The luminance of this phosphor at that moment is assumed to be 100. (Hereinafter, luminance of emitted light of the phosphors on excitation by 172 nm light exposure is shown as a relative value to the luminance of the phosphor 1 which is assumed to be 100.) The results of measurement of luminance of the phosphors on excitation by 172 nm light exposure are shown in Table 2.

When the phosphor 1 was irradiated with ultraviolet light of wavelength 365 nm under normal pressure at room temperature by using a fluorescence spectrophotometer (EP-6500 mfd. by JASCO Corporation), it was found that this phosphor emits light of blue color with the peak of light emission at 477 nm. The intensity of light at the peak of light emission is here assumed to be 100. (Hereinafter, the intensity of light at the peak of light emission by the phosphors is shown as a relative value to the intensity at the peak of light emission by the phosphor 1 which is assumed to be 100.) The results of measurement of light intensity at the peak of light emission by the phosphors on excitation by 365 nm light exposure are shown in Table 3.

The phosphor 1 was irradiated with the electron beams with an irradiation area of 1 μmφ at an acceleration voltage of 15 kV and a sample current of 50 nA in an apparatus comprising an electron beam microanalyzer (EPMA-1610 mfd. by Shimadzu Corp.) adapted with a photomultiplier detector. It was found that this phosphor emits blue light with the peak of emission at 480 nm. The intensity of light at the peak of emission is assumed to be 100. (Hereinafter, the intensity of light at the peak of light emission by the electron beam-excited phosphors is shown as a relative value to the intensity at the peak of light emission by the phosphor 1 which is assumed to be 100.) The results of measurement of intensity at the peak of light emission by the phosphors excited by the electron beams are shown in Table 4.

### Example 1

Barium carbonate (produced by Nippon Chemical Industries Co., Ltd.; purity: 99% or above), strontium carbonate (produced by Sakai Chemical Industries Co., Ltd.; purity: 99% or above), zirconium oxide (produced by Wako Pure Chemical Industries Co., Ltd.; purity: 99.99%), silicon dioxide (produced by Nippon Aerogil Co., Ltd.; purity: 99.99%) and europium oxide (produced by Shin-Etsu Chemical Industries Co., Ltd.; purity: 99.99%) were weighed out to have a composition of Ba:Sr:Zr:Si:Eu=0.75:0.23:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,350° C. for 5 hours to obtain a phosphor 2 represented by the formula Ba_{0.75}Sr_{0.23}ZrSi₃O₉:Eu_{0.02}.

The phosphor 2 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 481 nm, and its relative luminance at that moment was 142. The result is shown in Table 1.

The phosphor 2 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 480 nm, and its relative luminance at that moment was 181. The result is shown in Table 2.

When the phosphor 2 was irradiated with ultraviolet light of 365 nm under normal pressure at room temperature by using a fluorescence spectrophotometer (EP-6500 mfd. by JASCO Corporation), it was found that this phosphor emits light of blue color with its peak at 478 nm, and its relative intensity at the peak of light emission was 121. The result is shown in Table 3.

### Example 2

Barium carbonate (produced by Nippon Chemical Industries Co., Ltd.; purity: 99% or above), strontium carbonate (produced by Sakai Chemical Industries Co., Ltd.; purity: 99% or above), zirconium oxide (produced by Wako Pure Chemical Industries Co., Ltd.; purity: 99.99%), silicon dioxide (produced by Nippon Aerogil Co., Ltd.; purity: 99.99%) and europium oxide (produced by Shin-Etsu Chemical Industries Co., Ltd.; purity: 99.99%) were weighed out to have a composition of Ba:Sr:Zr:Si:Eu=0.5:0.48:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,350° C. for 5 hours to obtain a phosphor 3 represented by the formula Ba_{0.5}Sr_{0.48}ZrSi₃O₉:Eu_{0.02}. The X-ray diffraction pattern of the phosphor 3 is shown in FIG. 2. It was found from FIG. 2 that the phosphor 3 had a benitoite type crystal structure.

The phosphor 3 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 481 nm, and its relative luminance at that moment was 156. The result is shown in Table 1.

The phosphor 3 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 480 nm, and its relative luminance at that moment was 204. The result is shown in Table 2.

When the phosphor 3 was irradiated with ultraviolet light of wavelength 365 nm under normal pressure at room temperature by using a fluorescence spectrophotometer (EP-6500 mfd. by JASCO Corporation), it was found that this phosphor emits light of blue color with the peak of light emission at 478 nm, and its relative intensity at the peak of light emission was 193. The result is shown in Table 3.

The phosphor 3 was irradiated with the electron beams with an irradiation area of 1 μmφ at an acceleration voltage of 15 kV and a sample current of 50 nA in an apparatus comprising an electron beam microanalyzer (EPMA-1610 mfd. by Shimadzu Corp.) adapted with a photomultiplier detector. It was found that this phosphor emits blue light with the peak of emission at 480 nm. The relative intensity of light at the peak of emission was 343. The result is shown in Table 4.

### Example 3

Barium carbonate (produced by Nippon Chemical Industries Co., Ltd.; purity: 99% or above), strontium carbonate (produced by Sakai Chemical Industries Co., Ltd,; purity: 99% or above), zirconium oxide (produced by Wako Pure Chemical Industries Co., Ltd.; purity: 99.99%), silicon dioxide (produced by Nippon Aerogil Co., Ltd.; purity: 99.99%)) and europium oxide (produced by Shin-Etsu Chemical Industries Co., Ltd.; purity: 99.99%) were weighed out to have a composition of Ba:Sr:Zr:Si:Eu=0.25:0.73:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,350° C. for 5 hours to obtain a phosphor 4 represented by the formula Ba_{0.25}Sr_{0.73}ZrSi₃O₉:Eu_{0.02}.

The phosphor 4 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 481 nm, and its relative luminance at that moment was 109. The result is shown in Table 1.

The phosphor 4 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of blue color with its peak at 480 nm, and its relative luminance at that moment was 101. The result is shown in Table 2.

When the phosphor 4 was irradiated with ultraviolet light of wavelength 365 nm under normal pressure at room temperature by using a fluorescence spectrophotometer (EP-6500 mfd. by JASCO Corporation), it was found that this phosphor emits light of blue color with the peak of light emission at 478 nm. Its relative intensity at the peak of light emission was 105. The result is shown in Table 3.

### Comparative Example 2

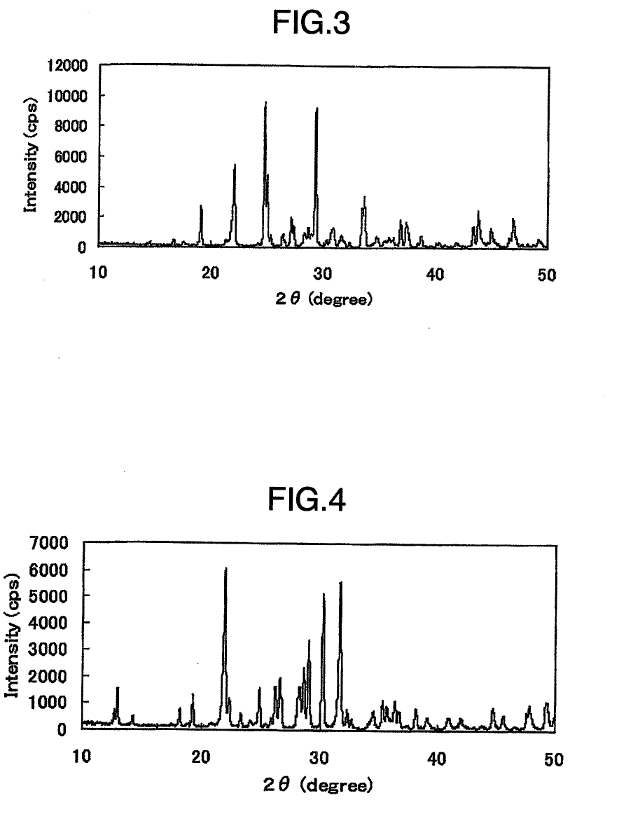

Strontium carbonate (produced by Sakai Chemical Industries Co., Ltd.; purity: 99% or above), zirconium oxide (produced by Wako Pure Chemical Industries Co., Ltd.; purity: 99.99%), silicon dioxide (produced by Nippon Aerogil Co., Ltd.; purity: 99.99%)) and europium oxide (produced by Shin-Etsu Chemical Industries Co., Ltd.; purity: 99.99%) were weighed out to have a composition of Sr:Zr:Si:Eu=0.98:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,350° C. for 5 hours to obtain a phosphor 5₂. The X-ray diffraction pattern of the phosphor 5 is shown in FIG. 3. It was found from FIG. 3 that the crystal structure of the phosphor 5 is different from that of the phosphor 3.

The phosphor 5 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of red color, and the relative luminance of the light at that point was 9. The result is shown in Table 1.

The phosphor 5 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of red color, and the relative luminance of the light at that moment was 10. The result is shown in Table 2.

When the phosphor 5 was irradiated with ultraviolet light of wavelength 365 nm under normal pressure at room temperature by using a fluorescence spectrophotometer (EP-6500 mfd. by JASCO Corporation), it was found that this phosphor emits light of red color, and its relative intensity at the peak of light emission was 8. The result is shown in Table 3.

### Comparative Example 3

Calcium carbonate (produced by Ube Materials Co., Ltd.; purity: 99% or above), zirconium oxide (produced by Wako Pure Chemical Industries Co., Ltd.; purity: 99.99%), silicon dioxide (produced by Nippon Aerogil Co., Ltd.; purity: 99.99%) and europium oxide (produced by Shin-Etsu Chemical Industries Co., Ltd.; purity: 99.99%) were weighed out to have a composition of Ca:Zr:Si:Eu=0.98:1:3:0.02 in molar ratio. The weighed out compounds were mixed by a dry ball mill for 4 hours and the mixture was packed in an alumina boat and baked in a reducing atmosphere of a nitrogen/hydrogen mixed gas (containing 2 vol % of hydrogen) at 1,350° C. for 5 hours to obtain a phosphor 6. The X-ray diffraction pattern of the phosphor 6 is shown in FIG. 4. It was found from FIG. 4 that the crystal structure of the phosphor 6 is different from that of the phosphor 3.

The phosphor 6 was irradiated with vacuum ultraviolet light from an excimer 146 nm lamp (H0012 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp. The observed light emission was of red color, and its relative luminance at that moment was 13. The result is shown in Table 1.

The phosphor 6 was irradiated with vacuum ultraviolet light from an excimer 172 nm lamp (H0016 mfd. by Ushio Inc.) in a vacuum chamber of 6.7 Pa (5×10⁻² Torr) or below and room temperature (approximately 25° C.), and the resulting light emission was evaluated by a spectroradiometer (SR-3 mfd. by Topcon Corp.). The observed light emission was of red color, and its relative luminance at that moment was 19. The result is shown in Table 2.

When the phosphor 6 was irradiated with ultraviolet light of wavelength 365 nm under normal pressure at room temperature by using a fluorescence spectrophotometer (FP-6500 mfd. by JASCO Corporation), it was found that this phosphor emits light of red color, with its relative intensity at the peak of light emission was 18. The result is shown in Table 3.

TABLE 1
Luminance of phosphors on exposure
to light of wavelength 146 nm

| | | Relative luminance |
|---|---|---|
| | | (when excited by 146 |
| | Composition | nm light exposure) |
| Phosphor 1 | Ba_{0.98}ZrSi₃O₉:Eu_{0.02} | 100 |
| Phosphor 2 | Ba_{0.75}Sr_{0.23}ZrSi₃O₉:Eu_{0.02} | 142 |
| Phosphor 3 | Ba_{0.5}Sr_{0.48}ZrSi₃O₉:Eu_{0.02} | 156 |
| Phosphor 4 | Ba_{0.25}Sr_{0.73}ZrSi₃O₉:Eu_{0.02} | 109 |
| Phosphor 5 | Sr_{0.98}ZrSi₃O₉:Eu_{0.02} | 9 |
| Phosphor 6 | Ca_{0.98}ZrSi₃O₉:Eu_{0.02} | 13 |

TABLE 2
Luminance of phosphors on exposure
to light of wavelength 172 nm

| | | Relative luminance |
|---|---|---|
| | | (when excited by 172 |
| | Composition | nm light exposure) |
| Phosphor 1 | Ba_{0.98}ZrSi₃O₉:Eu_{0.02} | 100 |
| Phosphor 2 | Ba_{0.75}Sr_{0.23}ZrSi₃O₉:Eu_{0.02} | 181 |
| Phosphor 3 | Ba_{0.5}Sr_{0.48}ZrSi₃O₉:Eu_{0.02} | 204 |
| Phosphor 4 | Ba_{0.25}Sr_{0.73}ZrSi₃O₉:Eu_{0.02} | 101 |
| Phosphor 5 | Sr_{0.98}ZrSi₃O₉:Eu_{0.02} | 10 |
| Phosphor 6 | Ca_{0.98}ZrSi₃O₉:Eu_{0.02} | 19 |

TABLE 3
Luminance of phosphors on exposure
to light of wavelength 365 nm

| | | Relative luminance |
|---|---|---|
| | | (when excited by 365 |
| | Composition | nm light exposure) |
| Phosphor 1 | Ba_{0.98}ZrSi₃O₉:Eu_{0.02} | 100 |
| Phosphor 2 | Ba_{0.75}Sr_{0.23}ZrSi₃O₉:Eu_{0.02} | 121 |
| Phosphor 3 | Ba_{0.5}Sr_{0.48}ZrSi₃O₉:Eu_{0.02} | 193 |
| Phosphor 4 | Ba_{0.25}Sr_{0.73}ZrSi₃O₉:Eu_{0.02} | 105 |
| Phosphor 5 | Sr_{0.98}ZrSi₃O₉:Eu_{0.02} | 8 |
| Phosphor 6 | Ca_{0.98}ZrSi₃O₉:Eu_{0.02} | 18 |

TABLE 4
Luminance of phosphors on exposure to electron beams of 15 kV

| | | Relative luminance |
|---|---|---|
| | | (when excited by 15 |
| | Composition | kV electron beams) |
| Phosphor 1 | Ba_{0.98}ZrSi₃O₉:Eu_{0.02} | 100 |
| Phosphor 3 | Ba_{0.5}Sr_{0.48}ZrSi₃O₉:Eu_{0.02} | 343 |

### INDUSTRIAL APPLICABILITY

The phosphor according to the present invention is capable of emitting light of high intensity, so that it is especially suited for application to the vacuum ultraviolet-excited light-emitting devices such as plasma display panels. The phosphor of this invention is also applicable to the ultraviolet-excited light-emitting devices such as backlight for liquid crystal displays, electron beam-excited light-emitting devices such as field emission displays, and other types of light-emitting devices such as white LED.

1. A phosphor comprising:
an oxide containing M¹, M² and M³ (wherein M¹ represents at least two elements selected from the group consisting of Ba, Sr and Ca; M² represents at least one element selected from the group consisting of Ti, Zr and Hf; and M³ represents at least one element selected from the group consisting of Si and Ge) as a base material; and
(an) activator(s).

2. The phosphor according to claim 1 wherein the oxide containing M¹, M² and M³ is represented by the formula (1):
aM¹O.bM²O₂.cM³O₂ (1)
wherein M¹ represent at least two elements selected from the group consisting of Ba, Sr and Ca;
M² represents at least one element selected from the group consisting of Ti, Zr and Hf;
M³ represents at least one element selected from the group consisting to Si and Ge;
a is not less than 0.5 and not more than 1.5;
b is not less than 0.5 and not more than 1.5; and
c is not less than 2 and not more than 4.

3. The phosphor according to claim 1 wherein the activator is Eu.

4. The phosphor according to claim 1 wherein M¹ is Ba and Sr.

5. A phosphor represented by the formula (2):
(Ba_{1-x-y}SrₓEu_{y})ZrSi₃O₉ (2)
wherein x is not less than 0.2 and not more than 0.8;
y is not less than 0.0001 and not more than 0.5; and
x+y=0.8 or less.

6. A phosphor paste comprising the phosphor according to claim 1.

7. A phosphor layer obtained by applying the phosphor paste according to claim 6 on a substrate, followed by a heat treatment.

8. A light-emitting device having incorporated therein the phosphor according to claim 1.
